(19) United States
(12) Patent Application Publication
(10) Pub. No.: US 2002/0105156 A1
(43) Pub. Date: Aug. 8, 2002

(54) Disc golf bagcart

(76) Inventor: Kerry L. Glidden, Kentwood, MI (US)

Correspondence Address: James E. Bartek, 3830- 56th Street, Grandville, MI, 49418, US

(21) Appl. No.: 09/776,134

(22) Filed: Feb. 2, 2001

(51) Int. Cl. B62B 1/00

(52) U.S. Cl. 280/47.19; 280/47.35

(57) ABSTRACT

A disc golf bagcart has a frame, a handle, wheels, and a disc compartment. The handle extends generally upward from the frame, when the frame is in an upright standing position, The wheels is at least a pair of wheels. Further, the wheels are operatively connected with the frame. As to the disc compartment, the disc compartment is integrally formed within the frame and is adapted to removably receive a preselected assortment of disc golf golfing discs. The frame has a frame length, the disc compartment may extend along the frame length, and the discs may be stacked along the frame length with the discs being oriented generally perpendicular to the frame length. The disc compartment may also be subdivided into compartment sections. Alternatively, the discs may be stacked along a direction that is generally perpendicular to the frame length. The frame length may also extend in one of a generally vertical and a generally horizontal direction, when the frame is in a standing position. The disc compartment may be defined by at least three elongated frame members that are generally parallel with one another and that extend along the frame length. Alternatively, the disc compartment may be defined within a generally cylindrical frame member. The cylindrical frame member preferably has a longitudinal slot that defines an access through which golfing discs are placed in and removed from the disc compartment. Finally, the frame may also define an interior space as the disc compartment, that is adapted to removably receive a preselected assortment of disc golf golfing discs.

### CROSS-REFERENCES TO RELATED APPLICATIONS

Not Applicable.

### STATEMENT REGARDING FEDERALLY SPONSORED Research or Development

Not Applicable.

### BACKGROUND OF THE INVENTION

The invention relates to the game of disc golf and more particularly to an unique accessory for the carrying of a selection of disc golf golfing discs about a disc golf course during play of the game.

Throwing disks have been known for literally centuries. A Merriam Webster dictionary places the origins of the word discus, which is a sport of throwing disks, at 1656 A.D., for example. More recently, the Wham-O Manufacturing Company of California made throwing disks popular with the introduction of the Frisbee® in about 1957. Even more recently, throwing disks have been used to play a modified form of the ancient game of golf, namely, disc golf The Professional Disc Golf Association ( http://pdga.com/index.phtml ) claims its origins in the year 1976.

As of yet, however, the common method of carrying one's set of disc golf discs comprises a duffel bag with a shoulder strap. Alternatively, the duffel is hung from a conventional golf cart. The official PDGA weight limit for golfing discs is 200 grams (0.44 pounds), which is somewhat under half a pound. If a person is carrying a duffel bag of about a dozen or so discs, not to mention other sundry items like water and sun screen, for example, the task can become somewhat of a burden in the course of a round of disc golf If the duffel is merely slung over one's shoulder, then one may also easily realize the potential for back strain and other skeletal implications. An everyday comparison may be the carrying about of a laptop computer in a briefcase or other carry bag.

Thus, a need for convenient and comfortable carrying of a set of golfing discs is clear.

### BRIEF SUMMARY OF THE INVENTION

Accordingly, a disc golf bagcart of the invention is a cart device that is particularly structured to the requirements of carrying a set of disc golf golfing discs during play of disc golf The bagcart is a unitary device that serves the specific requirements of disc golf with an inseparable combination of the traditional golf functions of a bag and a cart. Thus, the term bagcart is created consistent with the invention.

A disc golf bagcart has a frame, a handle, wheels, and a disc compartment. The handle extends generally upward from the frame, when the frame is in an upright standing position, The wheels is at least a pair of wheels. Further, the wheels are operatively connected with the frame. As to the disc compartment, the disc compartment is integrally formed within the frame and is adapted to removably receive a preselected assortment of disc golf golfing discs.

In other aspects of the invention, the frame has a frame length, the disc compartment extends along the frame length, and the discs are stacked along the frame length with the discs being oriented generally perpendicular to the frame length. The frame length may extend in one of a generally vertical and a generally horizontal direction, when the frame is in a standing position. The disc compartment may also be subdivided into compartment sections.

In one aspect of the invention, the disc compartment may be defined by at least three elongated frame members that are generally parallel with one another and that extend along the frame length. In another aspect of the invention, the disc compartment may be defined within a generally cylindrical frame member. The cylindrical frame member preferably has a longitudinal slot that defines an access through which golfing discs are placed in and removed from the disc compartment. In yet another aspect of the invention, the disc compartment may be subdivided into compartment sections and the discs may be stacked along a direction that is generally perpendicular to the frame length. Finally, the frame may also define an interior space that is adapted to removably receive a preselected assortment of disc golf golfing discs.

These and other features, objects, and benefits of the invention will be recognized by one having ordinary skill in the art and by those who practice the invention, from the specification, the claims, and the drawing figures.

### BRIEF DESCRIPTION OF THE SEVERAL VIEWS OF THE DRAWING

FIG. 1 is a front perspective view of a disc golf bagcart of the invention, showing an accessory bag exploded from the bagcart and an assortment of discs in phantom;

FIG. 2 is a front elevational thereof;

FIG. 3 is a side elevational thereof;

FIG. 4 is a cross-sectional view thereof taken along line IV-IV of FIG. 2;

FIG. 5 is a top plan view thereof;

FIG. 6 is a back elevational view thereof; and

FIG. 7 is a horizontal cross-sectional view thereof taken along line VII-VII of FIG. 2; and

FIG. 8 is a front perspective view of a first alternative embodiment of a disc golf bagcart of the invention, showing an assortment of discs in phantom; and

FIG. 9 is a top plan view thereof; and

FIG. 10 is a front perspective view of a second alternative embodiment of a disc golf bagcart of the invention, showing an assortment of discs in phantom;

FIG. 11 is a front elevation thereof; and

FIG. 12 is a cross-sectional view thereof taken along line XII-XII of FIG. 10; and

FIG. 13 is a front perspective view of a third alternative embodiment of a disc golf bagcart of the invention, showing an assortment of discs in phantom;

FIG. 14 is a side elevational view thereof; and

FIG. 15 is a top plan view thereof; and

FIG. 16 is a front perspective view of a fourth alternative embodiment of a disc golf bagcart of the invention, showing an assortment of discs in phantom; and

FIG. 17 is a front perspective view of a fifth alternative embodiment of a disc golf bagcart of the invention, showing an assortment of discs in phantom;

FIG. 18 is a side elevational view thereof; and

FIG. 19 is an end elevational view thereof; and

FIG. 20 is the view of FIG. 1 showing the relative positions of the disc compartment and the accessory bag inverted.

### DETAILED DESCRIPTION OF THE INVENTION

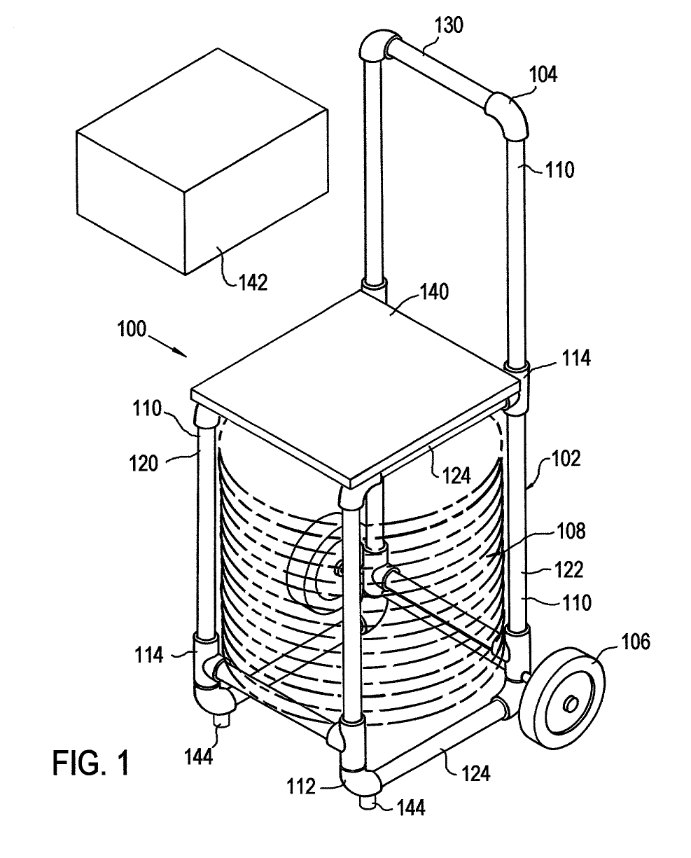

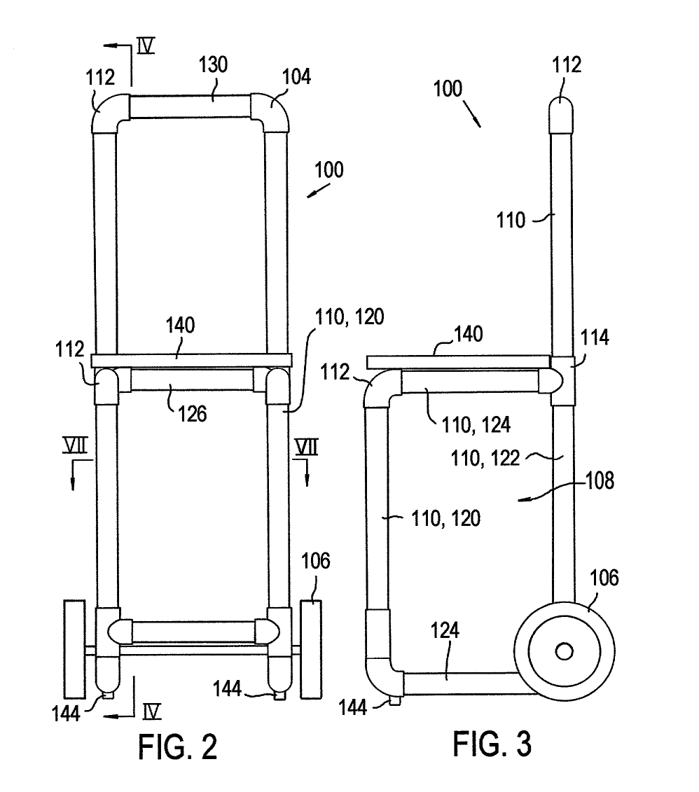

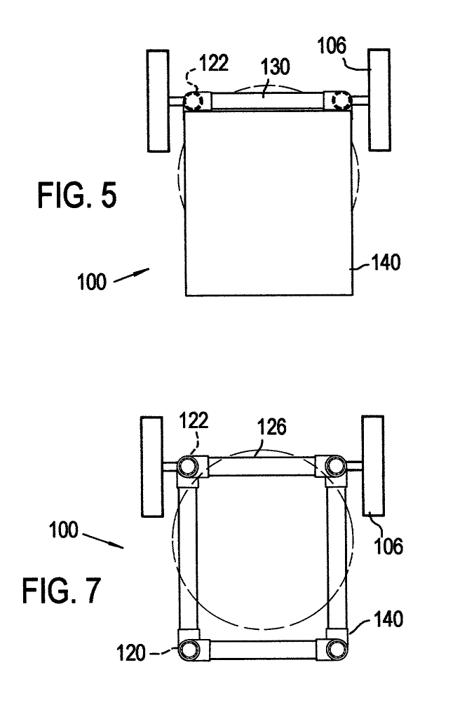

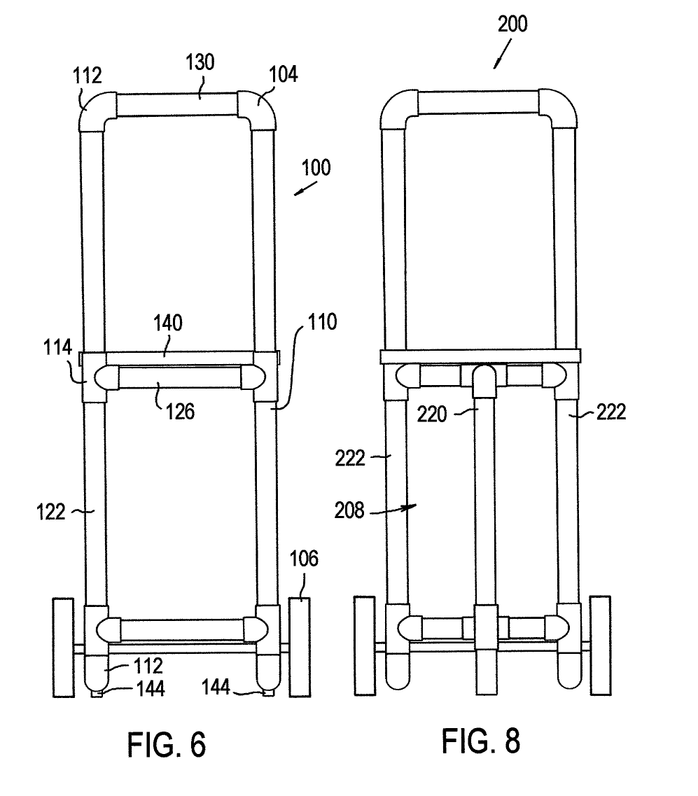

A preferred embodiment of a disc golf bagcart according to the invention is generally shown in the drawing figures and discussed below. A first embodiment of a bagcart 100 of the invention is generally shown in the drawing FIGS. 1-7. The bagcart 100 generally includes a frame 102, a handle 104, wheels 106, and a disc compartment 108.

The frame 102 is conveniently constructed of commonly available plastic plumbing tubing and fittings. More particularly, three quarter inch (19 mm) tubing may be cut to desired lengths 110 and cemented with elbow and tee fittings 112 and 114, respectively, as will be understood by one having ordinary skill in the art. The frame 102 may be considered a box frame with four elongated and generally vertical frame members, namely front and back members 120 and 122, respectively, that extend generally upward along a length of the frame and define the disc compartment 108. The disc compartment 108 is completed by front and rear running stringers 124 and laterally extending stringers 126.

The handle 104 extends generally upward from the back frame members 122 to a grab bar 130. Positioning the grab bar 130 at a height of about forty-four inches (1118 mm) should be comfortable for most users. The grab bar is preferably covered with a sticky wrap or a padded wrap for comfort as will be understood by one having ordinary skill in the art.

The wheels 106 are commonly available at most hardware stores and the like. Wheels of about six inch (152 mm) to about eight inch (203 mm) diameter with a non-pneumatic tire that has a tread of about one and a half inch (38 mm) width, mounted to a solid plastic disk rim have been found to provide good rolling resistance and floatation on a disc golf golfing course. Of course these dimensions are not critical and may be varied according to a user's or fabricator's preferences. The wheels 106 may be connected with the frame by mounting them on a steel rod axle 132. For the wheels used by the inventor, a half inch (13 mm) diameter rod served well. The back members 122 may be drilled so the axle 132 may be inserted through the back members. Of course, one having ordinary skill in the art will understand that bushing or bearing arrangements may be used between the axle 132 and the frame 102.

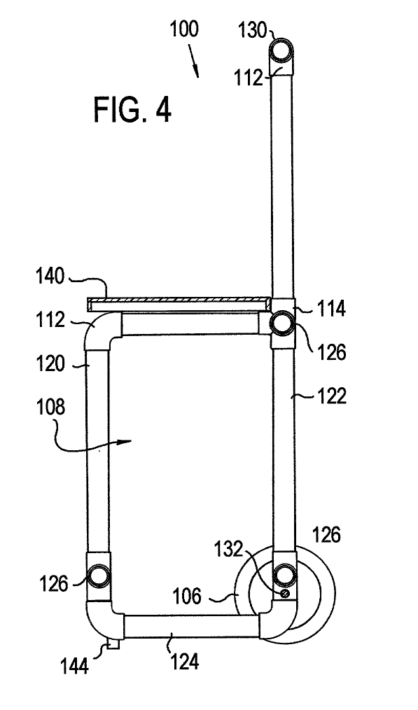

An optional shelf or seat 140 may be provided on the bagcart 100. An optional cooler or accessories bag 142 may also be used with the bagcart 100. A commonly known bottle cage (not shown) and other accessories may also be connected with the frame 102. Further, a user may find that adjustable or non-adjustable feet 144 (FIG. 4) may be desirable at the bottom front of the bagcart 100 when the bagcart is in a standing position as shown.

In use, a golfer's discs may be inserted into the disc compartment 108 by inserting the discs between the frame members 120 and 122, typically between the front members 120. The discs are likewise removed from the bagcart 100. Sundry items, such as sunglasses, medications, sun screen, or snacks, for example, may be stored in the optional bag 142. The user may then conveniently transport their selection of golfing discs and accessories about a disc golf golfing course, for example by merely grasping the grab bar 130 and pulling the bagcart 100.

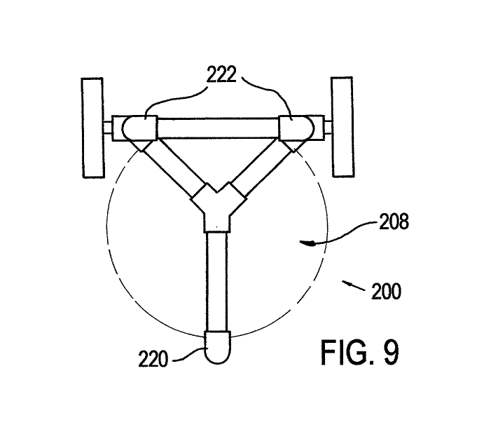

Of course, one having ordinary skill in the art will understand that the bagcart 100 is only one of several potential configurations for a bagcart of the invention. A first alternative embodiment of a bagcart 200 is shown in drawing FIGS. 8 and 9. The bagcart 200 is substantially similar to the bagcart 100 with the notable distinction that while the bagcart 100 uses a pair of front frame members 120 and a pair of back frame members 122 that define the disc compartment 108 in what may be termed a four post construction, the bagcart 200 uses a single front frame member 220 with a pair of back frame members 222 in what may be termed a three post construction to define the disc compartment 208. The three post construction of bagcart 200 may require specially fabricated connectors or fittings while the four post construction of bagcart 100 uses standard, off the shelf fittings.

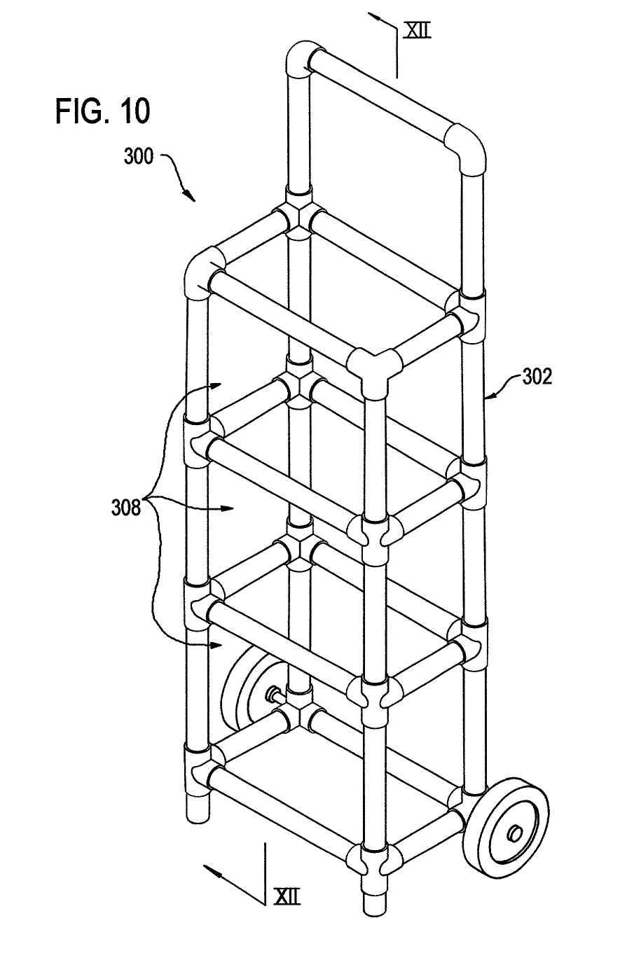

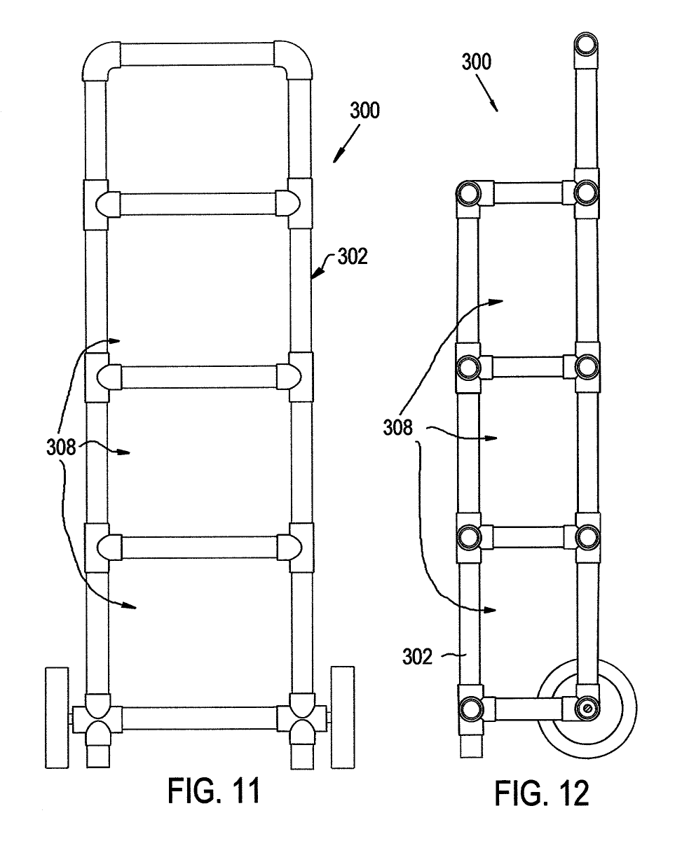

A second alternative embodiment of a bagcart 300 is shown in drawing FIGS. 10-12. The bagcart 300 is also substantially similar to the bagcart 100 with the notable distinction that while the bagcart 100 has the disc compartment 108 extending generally vertically, along a length of the frame 102, the disc compartment 308, which also extends generally vertically, along a length of the frame 302, is divided into sub compartments into which the selected golfing discs may be grouped in stacks that extend generally perpendicularly to the length of the frame 302.

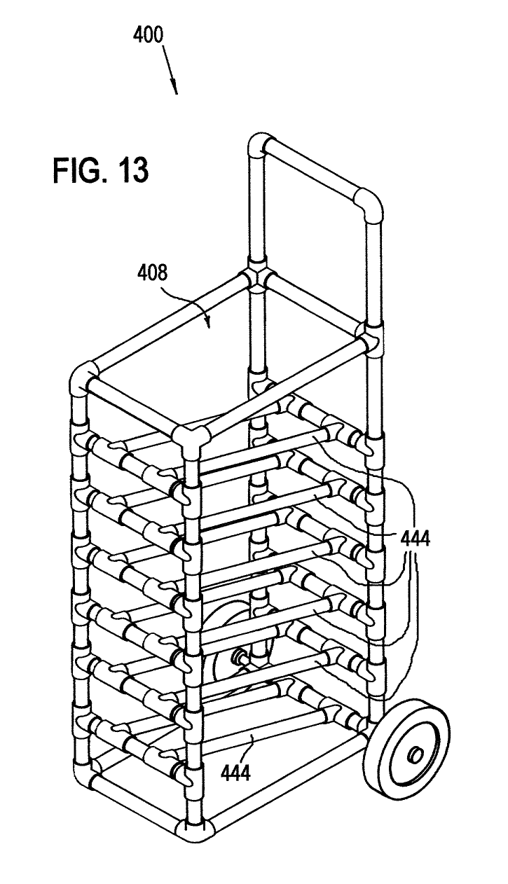

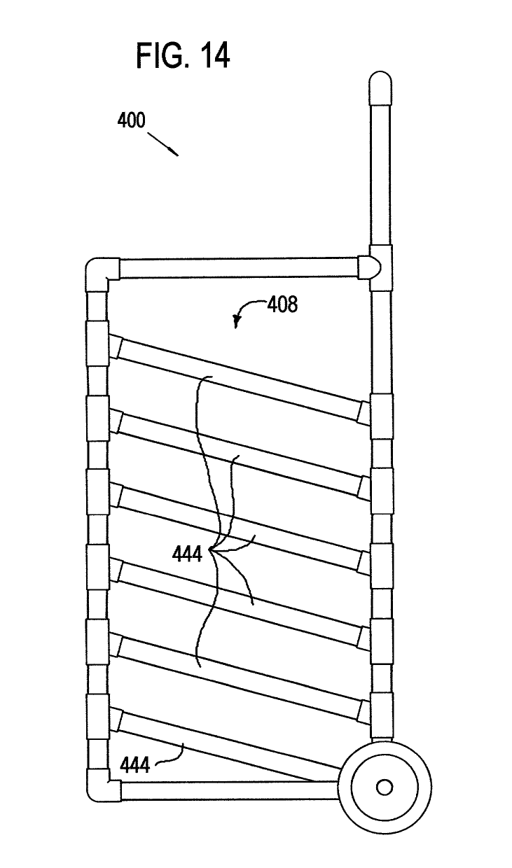

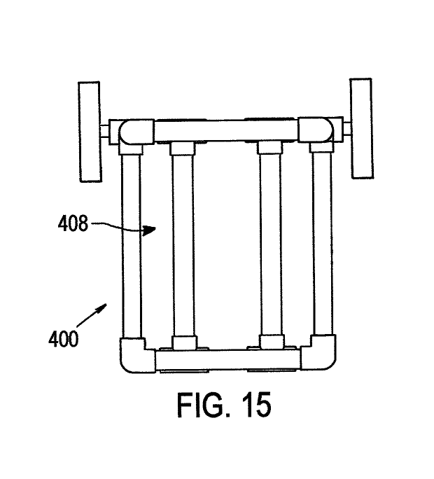

A third alternative embodiment of a bagcart 400 is shown in drawing FIGS. 13-15. The bagcart 400 is substantially similar to the bagcart 300 with the notable distinction that while the disc compartment 408 is further divided with shelves 444 upon which a very few or even a single golfing disc may be carried.

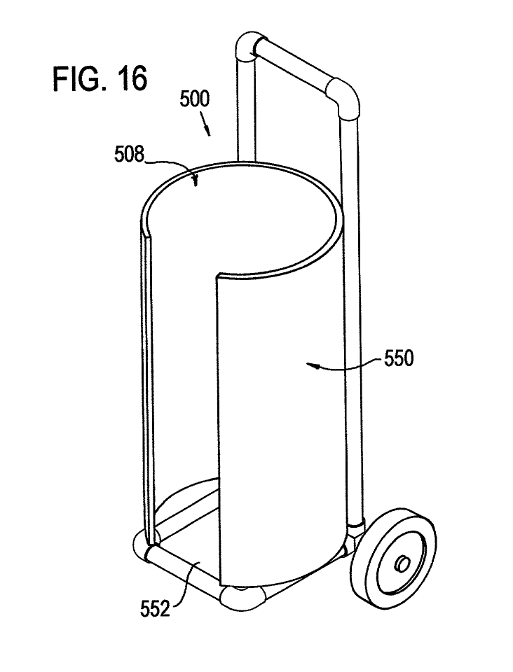

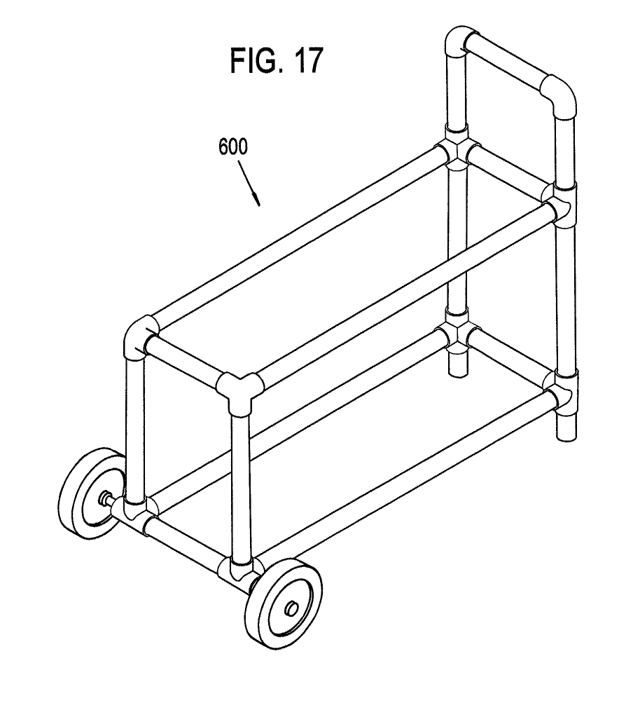

A fourth alternative embodiment of a bagcart 500 is shown in drawing FIG. 16. The bagcart 500 is exemplary of the disc compartment 508 being substantially defined by something other than an array of posts. In the bagcart 500, the disc compartment 508 is specifically defined by a cylindrical tube 550 that extends along the length of the frame 502. The tube 550 has an access slot 552 that extends along the length of the tube. One having ordinary skill in the art will understand from this disclosure that the second alternative embodiment 300 may also be further modified with tubular sections that extend generally perpendicular to the frame length, for example.

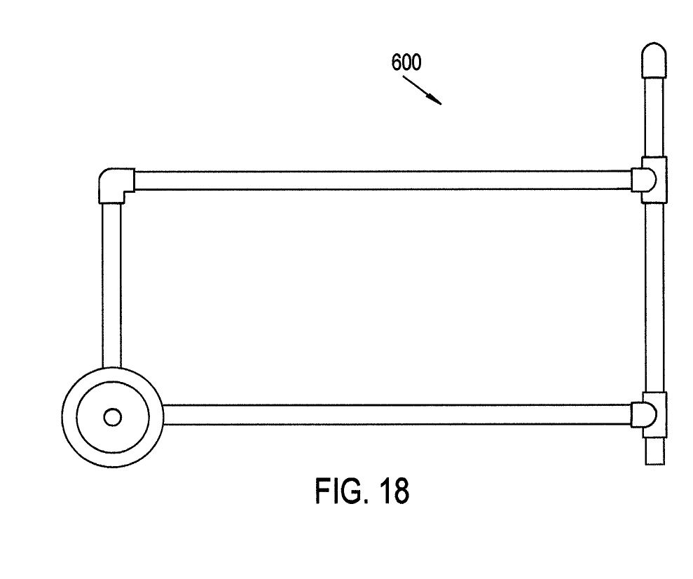

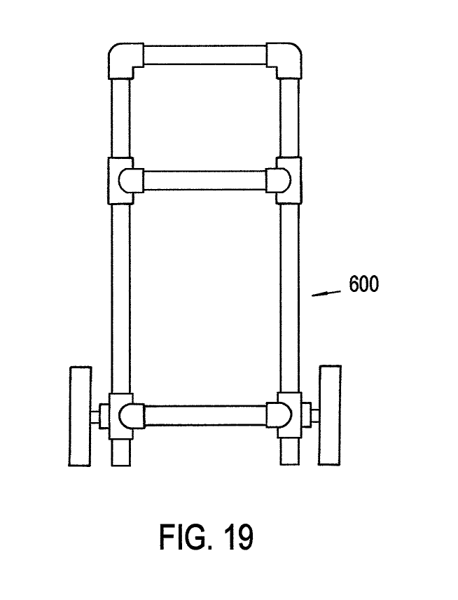

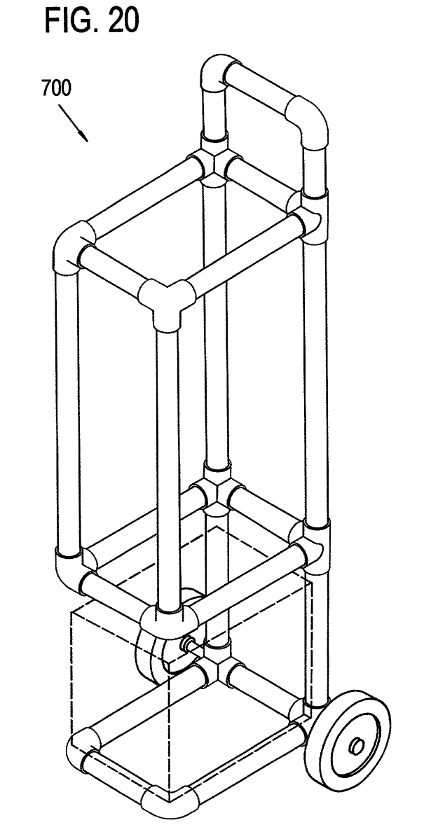

A fifth alternative embodiment of a bagcart 600 is shown in drawing FIGS. 17-19. The bagcart 600 is substantially similar to the bagcart 100 with the notable distinction that the frame length and disc compartment 608 extend generally horizontally.

Finally, a sixth alternative embodiment of a bagcart 700 is shown in drawing FIG. 20. The bagcart 700 is substantially similar to the bagcart 100 with the notable distinction that the relative positions of the disc compartment 708 and the optional accessory bag or cooler 742 have been exchanged.

Thus, one having ordinary skill in the art will understand from this disclosure that a great number of modifications and improvements may be made to the inventive concept without departing from the spirit of the disclosed invention. Various relational terms, including left, right, front, back top, and bottom, for example, are used in the detailed description of the invention and in the claims only to convey relative positioning of various elements of the claimed invention. The scope of protection afforded is to be determined by the claims and by the breadth of interpretation allowed by law.

I claim:

1. A disc golf bagcart comprising:
a frame;
a handle, the handle extending generally upward from the frame, when the frame is in an upright standing position;
at least a pair of wheels, the wheels being operatively connected with the frame; and
a disc compartment, the disc compartment being adapted to removably receive a preselected assortment of disc golf golfing discs, the disc compartment being integrally formed within the frame.

2. The bagcart defined in claim 1 wherein the frame has a frame length, wherein the disc compartment extends along the frame length, and wherein the discs are stacked along the frame length, the discs being oriented generally perpendicular to the frame length.

3. The bagcart defined in claim 2 wherein the frame length extends in one of a generally vertical and a generally horizontal direction, when the frame is in a standing position.

4. The bagcart defined in claim 2 wherein the disc compartment is subdivided into compartment sections.

5. The bagcart defined in claim 2 wherein the disc compartment is defined by at least three elongated frame members, the frame members being generally parallel with one another and extending along the frame length.

6. The bagcart defined in claim 2 wherein the disc compartment is defined within a generally cylindrical frame member.

7. The bagcart defined in claim 6 wherein the cylindrical frame member has a longitudinal slot. the slot defining an access through which golfing discs are placed in and removed from the disc compartment.

8. The bagcart defined in claim 1 wherein the frame has a frame length, wherein the disc compartment extends along the frame length, wherein the disc compartment is subdivided into compartment sections, and wherein the discs are stacked along a direction that is generally perpendicular to the frame length.

9. A disc golf bagcart comprising;
a frame, the frame defining an interior space, the interior space being adapted to removably receive a preselected assortment of disc golf golfing discs;
a handle, the handle extending generally upward from the frame, when the frame is in an upright standing position; and
at least a pair of wheels, the wheels being operatively connected with the frame.

10. The bagcart defined in claim 9 wherein the frame has a frame length, wherein the disc compartment extends along the frame length, and wherein the discs are stacked along the frame length, the discs being oriented generally perpendicular to the frame length.

11. The bagcart defined in claim 10 wherein the frame length extends in one of a generally vertical and a generally horizontal direction, when the frame is in a standing position.

12. The bagcart defined in claim 10 wherein the disc compartment is subdivided into compartment sections.

13. The bagcart defined in claim 10 wherein the disc compartment is defined by at least three elongated frame members, the frame members being generally parallel with one another and extending along the frame length.

14. The bagcart defined in claim 10 wherein the disc compartment is defined within a generally cylindrical frame member.

15. The bagcart defined in claim 14 wherein the cylindrical frame member has a longitudinal slot. the slot defining an access through which golfing discs are placed in and removed from the disc compartment.

16. The bagcart defined in claim 9 wherein the frame has a frame length, wherein the disc compartment extends along the frame length, wherein the disc compartment is subdivided into compartment sections, and wherein the discs are stacked along a direction that is generally perpendicular to the frame length.
